(19) United States
(12) Patent Application Publication
(10) Pub. No.: US 2023/0259843 A1
(43) Pub. Date: Aug. 17, 2023

(54) METHODS, INTERNET OF THINGS SYSTEMS AND STORAGE MEDIA FOR VISUALIZING WORK ORDERS OF SMART GAS PLATFORMS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Junyan ZHOU, Chengdu (CN)

(73) Assignee: CHENGDU QINCHUAN IOT TECHNOLOGY CO., LTD., Chengdu (CN)

(21) Appl. No.: 18/303,558

(22) Filed: Apr. 19, 2023

(51) Int. Cl. G06Q 10/0631; H04L 67/12; G06Q 50/06

(52) U.S. Cl. CPC G06Q 10/06313; H04L 67/12; G06Q 50/06

(57) ABSTRACT

The present disclosure provides a method, an Internet of Things system and a storage medium for visualizing a work order of a smart gas platform. The method is executed by a smart gas management platform of an Internet of Things system for visualizing a work order of a smart gas platform, the method comprises: obtaining work order management data and executor data; determining at least one candidate gas work order based on the work order management data and the executor data; generating, based on the at least one candidate gas work order, a first information to be presented; and generating a gas work order data graph based on the first information to be presented, the gas work order data graph being a visual chart.

### TECHNICAL FIELD

The present disclosure relates to the field of work order visualization, and in particular to a method, an Internet of Things system and a storage medium for visualizing a work order of a smart gas platform.

### BACKGROUND

A work order is a simple gas maintenance schedule consisting of one and more jobs. Due to the wide range of gas usage, there are inevitably a large number of work orders to be processed or unprocessed work orders in the process of gas usage. In the prior art, work order data is mainly managed using a work order data visualization technique.

For the problem of work order data visualization, CN 106339829 B discloses a panoramic monitoring system for actively repairing a distribution network based on big cloud and object shift technology, which can generate real-time information of work order processing and display it on a large monitoring screen or an electronic map in the form of text, and clarify a position of each work order in the link in combination with the realization of the divided work order processing process link settings. The work order data visualization of the system mainly involves the visualization of the geographic position of work orders and the visualization of the execution degree of work orders, and does not involve the dynamic prediction and display of work order execution time and work order execution problems. Therefore, the dynamic update of the visualization data graph of work order data needs to be improved.

Therefore, it is desired to provide a method and an Internet of Things system and a storage medium for visualizing a work order of a smart gas platform that enables dynamic updating of a visual data graph of a gas work order, avoiding lag in updating a gas work order, and improving the efficiency of gas work order interaction and processing based on the dynamically updated data graph.

### SUMMARY

One or more embodiments of the present disclosure provide a method for visualizing a work order of a smart gas platform. The method is executed by a smart gas management platform of an Internet of Things system for visualizing a work order of a smart gas platform, the method comprises: obtaining work order management data and executor data; determining at least one candidate gas work order based on the work order management data and the executor data; generating, based on the at least one candidate gas work order, a first information to be presented; wherein the first information to be presented includes at least one of a type of the at least one candidate gas work order, difficulty information of the at least one candidate gas work order, geographic position information of the at least one candidate gas work order, status information of the at least one candidate gas work order, and geographic position information of a work order executor; and generating a gas work order data graph based on the first information to be presented, the gas work order data graph being a visual chart.

One or more embodiments of the present disclosure provide an Internet of Things system for visualizing a work order of a smart gas platform, in the Internet of Things, the smart gas management platform of the Internet of Things system for visualizing a work order of a smart gas platform is configured to: obtain work order management data and executor data; determine at least one candidate gas work order based on the work order management data and the executor data; generate, based on the at least one candidate gas work order, a first information to be presented; wherein the first information to be presented includes at least one of a type of the at least one candidate gas work order, difficulty information of the at least one candidate gas work order, geographic position information of the at least one candidate gas work order, status information of the at least one candidate gas work order, and geographic position information of a work order executor; and generate a gas work order data graph based on the first information to be presented, the gas work order data graph being a visual chart.

One or more embodiments of the present disclosure provide a non-transitory computer-readable storage medium, comprising a set of instructions, wherein when executed by a processor, a method for visualizing a work order of a smart gas platform is implemented.

### BRIEF DESCRIPTION OF THE DRAWINGS

The present disclosure is further illustrated in terms of exemplary embodiments. These exemplary embodiments are described in detail with reference to the drawings. These embodiments are not limited. In these embodiments, the same number represents the same structure, wherein:

FIG. 1 is a schematic diagram illustrating an Internet of Things system for visualizing a work order of a smart gas platform according to some embodiments of the present disclosure;

FIG. 2 is a flowchart illustrating an exemplary method for visualizing a work order of a smart gas platform according to some embodiments of the present disclosure;

FIG. 3 is a flowchart illustrating an exemplary process for dynamically updating a gas work order data graph according to some embodiments of the present disclosure;

FIG. 4 is a flowchart illustrating an exemplary process for determining a matching degree between a work order executor and at least one gas work order according to some embodiments of the present disclosure;

FIG. 5 is a flowchart illustrating another exemplary process for determining the matching degree between a work order executor and at least one gas work order according to some embodiments of the present disclosure;

FIG. 6 is a flowchart illustrating an exemplary process for determining work order time distribution information according to some embodiments of the present disclosure.

### DETAILED DESCRIPTION

The technical schemes of embodiments of the present disclosure will be more clearly described below, and the accompanying drawings need to be configured in the description of the embodiments will be briefly described below. Obviously, the drawings in the following description are merely some examples or embodiments of the present disclosure, and will be applied to other similar scenarios according to these accompanying drawings without paying creative labor. Unless obviously obtained from the context or the context illustrates otherwise, the same numeral in the drawings refers to the same structure or operation.

It should be understood that the “system”, “device”, “unit” and/or “module” used herein is a method for distinguishing different components, elements, components, parts or assemblies of different levels. However, if other words may achieve the same purpose, the words may be replaced by other expressions.

As shown in the present disclosure and claims, unless the context clearly prompts the exception, “a”, “one”, and/or “the” is not specifically singular, and the plural may be included. It will be further understood that the terms “comprise,” “comprises,” and/or “comprising,” “include,” “includes,” and/or “including,” when used in present disclosure, specify the presence of stated features, integers, steps, operations, elements, and/or components, but do not preclude the presence or addition of one or more other features, integers, steps, operations, elements, components, and/or groups thereof.

The flowcharts are used in present disclosure to illustrate the operations performed by the system according to the embodiment of the present disclosure. It should be understood that the preceding or following operations is not necessarily performed in order to accurately. Instead, the operations may be processed in reverse order or simultaneously. Moreover, one or more other operations may be added to the flowcharts. One or more operations may be removed from the flowcharts.

For a large amount of work orders to be processed or unprocessed work orders that exist in the process of gas usage, the work order data visualization technique is mainly used to manage the work order data. CN 106339829 B only generates real-time information of work order processing and displays it on a monitoring screen or electronic map in the form of text, and also clarifies a position of each work order in the link by combining with the realization of the divided work order processing process link setting, so the visualization of work order data only involves the visualization of the geographic position of work orders and the visualization of the execution degree of work orders, and does not involve the dynamic prediction and display of work order execution time, work order execution problems, etc.

In view of this, in some embodiments of the present disclosure, it is desired to provide a method for visualizing a work order of a gas platform, which is used for predicting a candidate gas work order based on gas work order management data and work order executor data monitored by the object platform, and then generating a gas work order data graph, and then sending the dynamically updated gas work order data graph to at least one user terminal in response to a request of a user terminal, when the user terminal returns feedback information, correspondingly updating the gas work order data graph, thus realizing the dynamic update of the visual data graph of gas work orders, avoiding the lag in updating gas work orders, and improving the interaction efficiency and processing efficiency of gas work orders based on the dynamically updated data graph.

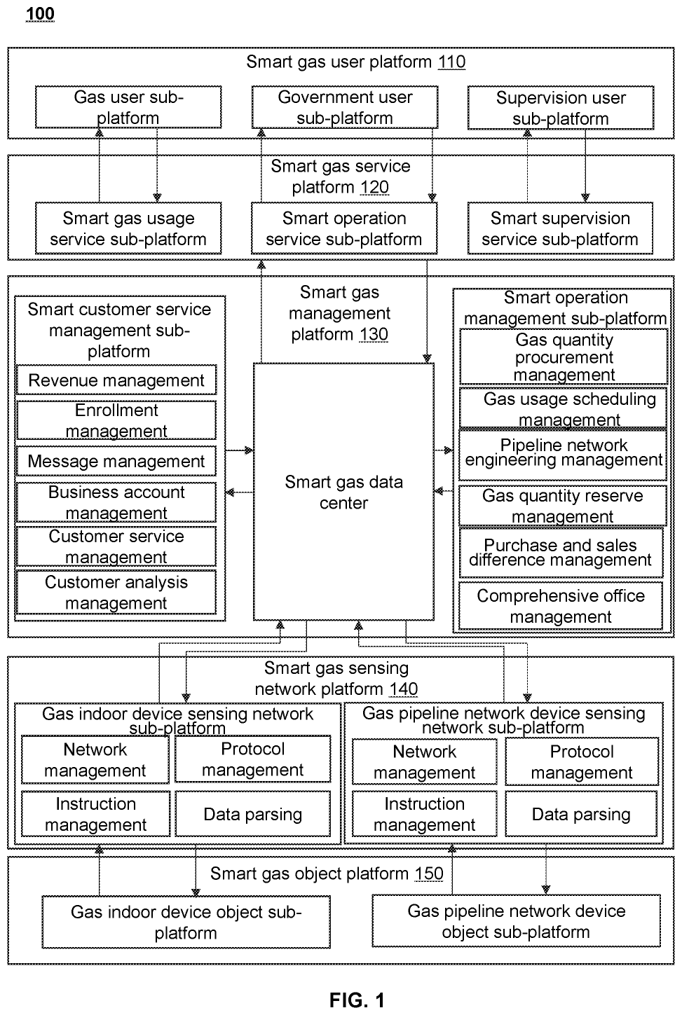

FIG. 1 is a schematic diagram illustrating an Internet of Things system for visualizing a work order of a smart gas platform according to some embodiments of the present disclosure.

As shown in FIG. 1, the Internet of Things system for visualizing a work order of a smart gas platform includes: a smart gas user platform 110, a smart gas service platform 120, a smart gas management platform 130, a smart gas sensing network platform 140, and a smart gas object platform 150 that interact in sequence.

The smart gas user platform 110 is a user-driven platform that may be used to interact with a user. The user may be a gas user, a government user, a supervision user, etc. In some embodiments, the smart gas user platform 110 may send feedback information and a gas operation management information query instruction from the gas user to the smart gas service platform 120, and receive gas operation management information uploaded by the smart gas service platform 120. In some embodiments, the gas operation management information may include gas work order visualization information. The gas work order visualization information may include basic information of a work order, matching information of an executor, etc. In some embodiments, the smart gas user platform 110 may include a gas user sub-platform, a government user sub-platform, a supervision user sub-platform, etc.

The gas user sub-platform is used to feed gas usage related data and a gas problem solution, etc. back for a gas user (e.g., a gas consumer, etc.). In some embodiments, the gas user sub-platform may correspond to and interact with the smart gas service sub-platform to obtain a safe gas usage service.

The government user sub-platform is used to feed gas operation-related data, etc., back for a government user (e.g., a government department that manages city gas safety efforts). For example, information such as gas safety usage inspection frequency, gas pipeline network line distribution, etc. is provided for the government user. In some embodiments, the gas user sub-platform may correspond to and interact with a smart operation service sub-platform to obtain a gas operation-related service.

The supervision user sub-platform is used to supervise the operation of the entire Internet of Things system for a supervision user (e.g., a user of a security department, etc.). In some embodiments, the supervision user sub-platform may correspond to and interact with a smart supervision service sub-platform to obtain a service for safety supervision needs.

The smart gas service platform 120 may be a platform for receiving and transmitting data and/or information. In some embodiments, the smart gas service platform 120 may include a smart gas usage service sub-platform, a smart operation service sub-platform, a smart supervision service sub-platform, etc.

The smart gas usage service sub-platform may correspond to the gas user sub-platform to provide gas device related information to the gas user. The smart operation service sub-platform may correspond to the government user sub-platform to provide gas operation related information for the government user. The smart supervision service sub-platform may correspond to the supervision user sub-platform to provide a service for safety supervision needs for the supervision user.

In some embodiments, the smart gas service platform 120 may be used to interact upwardly with the smart gas user platform 110. For example, receiving an operation management information query instruction from the smart gas user platform 110; uploading operation management information to the smart gas user platform 110, etc. In some embodiments, the smart gas service platform 120 may also be used to interact downwardly with the smart gas management platform 130. For example, sending a gas operation management information query instruction to the smart gas management platform 130, receiving operation management information uploaded by the smart gas management platform 130, etc.

The smart gas management platform 130 may be an Internet of Things platform that coordinates and harmonizes connections and collaboration among functional platforms to provide perceptual management and control management. For example, the smart gas management platform 130 may assign repair personnel, emergency repair personnel, and maintenance personnel based on work order data, and coordinate the gas device based on operation information, etc. In some embodiments, the smart gas management platform 130 may include a smart customer service management sub-platform, a smart operation management sub-platform, and a smart gas data center.

The smart customer service management sub-platform is a platform for managing gas customer services (e.g., enrollment management, message management). In some embodiments, the smart customer service management sub-platform may include multiple functions such as revenue management, enrollment management, message management, business account management, customer service management, and customer analysis management. The enrollment management may be used to register information reported by gas users for enrollment, maintenance, and consultation. The message management may be used to push messages about new tasks and extensions of tasks to be processed to personnel; push messages about device monitoring and alarms, gas usage monitoring and alarms, gas usage abnormalities, etc. to personnel and/or users, and push system notification messages such as gas outage notification and gas outage scope. The customer service management may be used to return the results of work order processing and customer satisfaction survey, etc.

The smart operation management sub-platform is a platform for managing gas operations (e.g., gas quantity procurement, gas usage scheduling). In some embodiments, the smart operation management sub-platform may include various functions such as gas quantity procurement management, gas usage scheduling management, pipeline network engineering management, gas quantity reserve management, purchase and sales difference management, and comprehensive office management. The comprehensive office management may be used to coordinate the operation's human resources, public resources, gas devices, daily office, administration and other matters.

The smart gas data center may be used to aggregate and store all operation data of the system. For example, the smart gas data center may store management data of various indoor and pipeline network devices, operation data of various devices, and various query instructions sent by users.

In some embodiments, the smart customer service management sub-platform and the smart operation management sub-platform are independent of each other. In some embodiments, the smart customer service management sub-platform and the smart operation management sub-platform interact with the smart gas data center in both directions, respectively. For example, the smart customer service management sub-platform and the smart operation management sub-platform separately obtain related data from the smart gas data center and feed back related information processed by related management modules.

In some embodiments, the smart gas management platform 130 interacts with the smart gas service platform 120 and the smart gas sensing network platform 140 through the smart gas data center. For example, the smart gas data center may receive a gas operation management information query instruction from the smart operation service sub-platform, and receive gas user feedback information from the smart gas service sub-platform. The smart gas data center may send an instruction to obtain gas device related data to the smart gas sensing network platform 140, and receive gas pipeline network related information (e.g., gas device related data) uploaded by the smart gas sensing network platform 140. In some embodiments, the gas device related data may include gas pipeline network related operation data of different regions. The smart gas data center may send the gas user feedback information and the gas pipeline network related information to the smart operation management sub-platform for processing. The smart operation management sub-platform may send the processed gas operation management information to the smart gas data center. The smart gas data center may send the gas operation management information (e.g., work order visualization information) to the smart gas service platform 120. In some embodiments, the work order visualization information is ultimately displayed in a client (e.g., an app) of the smart gas user platform 110.

In some embodiments, the smart gas management platform 130 may be used to interact upwardly with the smart gas service platform 120. For example, receiving a gas operation management information query instruction from the smart gas service platform 120; uploading gas operation management information to the smart gas service platform 120, etc. In some embodiments, the smart gas service platform 120 may also be used to interact downwardly with the smart gas sensing network platform 140. For example, sending an instruction to obtain gas device related data to the smart gas sensing network platform 140, receiving the gas device related data uploaded by the smart gas sensing network platform 140, etc.

The smart gas sensing network platform 140 may be a platform that enables an interaction between the smart gas management platform 130 and the smart gas object platform 150, which is configured as a communication network and gateway. In some embodiments, the smart gas sensing network platform 140 may include a gas indoor device sensing network sub-platform and a gas pipeline network device sensing network sub-platform.

In some embodiments, the gas indoor device sensing network sub-platform may correspond to the gas indoor device object sub-platform. The gas indoor device sensing network sub-platform may receive related data of the gas indoor device uploaded by the gas indoor device object sub-platform.

In some embodiments, the gas pipeline network device sensing network sub-platform may correspond to the gas pipeline network device object sub-platform. The gas pipeline network device sensing network sub-platform may receive related data of the gas pipeline network device uploaded by the gas pipeline network device object sub-platform.

In some embodiments, the gas indoor device sensing network sub-platform and the gas pipeline network device sensing network sub-platform both have network management, protocol management, instruction management, and data parsing functions. The network management is the management of the network, which enables the flow of data and/or information between the platforms and the modules. The protocol management is to manage various networks and communication protocols, which can realize the data and/or information exchange between platforms and modules executing different networks and communication protocols. The instruction management is the management of various instructions (e.g., instructions for receiving gas operation management information queries), which may store and execute various instructions. The data parsing is to parse various data, instructions, etc., which may parse various data, instructions, etc., so that each module and platform can recognize or execute them smoothly, etc.

In some embodiments, the smart gas sensing network platform 140 may be used to interact downwardly with the smart gas object platform 150. For example, receiving gas device related data uploaded by the smart gas object platform 150; sending an instruction to obtain the gas device related data to the smart gas object platform 150. In some embodiments, the smart gas sensing network platform 140 may also interact upwardly with the smart gas management platform 130. For example, receiving an instruction from the smart gas management platform 130 to obtain the gas device related data; uploading the gas device related data to the smart gas management platform 130.

The smart gas object platform 150 may be a functional platform for perceptual information generation and control information final execution, which is configured as various types of devices. The various types of devices may include gas devices and other devices. The gas devices may include indoor devices and pipeline network devices. In some embodiments, the smart gas object platform 150 may include a gas indoor device object sub-platform and a gas pipeline network device object sub-platform.

In some embodiments, the gas indoor device object sub-platform may correspond to the gas indoor device sensing network sub-platform. The gas indoor device object sub-platform may upload related data of the gas indoor device to the smart gas data center via the gas indoor device sensing network sub-platform.

In some embodiments, the gas pipeline network device object sub-platform may correspond to the gas pipeline network device sensing network sub-platform. The gas pipeline network device object sub-platform may upload related data of the gas pipeline network device to the smart gas data center via the gas pipeline network device sensing network sub-platform.

In some embodiments, the smart gas object platform 150 may interact upwardly with the smart gas sensing network platform 140. For example, receiving an instruction from the smart gas sensing network platform 140 to obtain gas device related data; uploading the gas device related data to the smart gas sensing network platform 140, etc.

In some embodiments of the present disclosure, by establishing an Internet of Things system for visualizing a work order of a smart gas platform, including a smart gas user platform 110, a smart gas service platform 120, a smart gas sensing network platform 140, and a smart gas object platform 150, a closed loop of smart gas management information is formed among a pipeline network device, a gas operator, a gas user, a government user, and a supervision user to visualize and smarten the pipeline network management information and ensure quality management efficiency.

It should be understood that the system shown in FIG. 1 and its modules may be implemented using various means. It should be noted that the above description of the system 100 and its modules is for descriptive convenience only and does not limit the present disclosure to the scope of the embodiments cited. It can be understood that for those skilled in the art, after understanding the principle of the system, they may, without departing from this principle, make any combination of the individual modules or form a subsystem to connect with other modules, all within the scope of protection of the present disclosure.

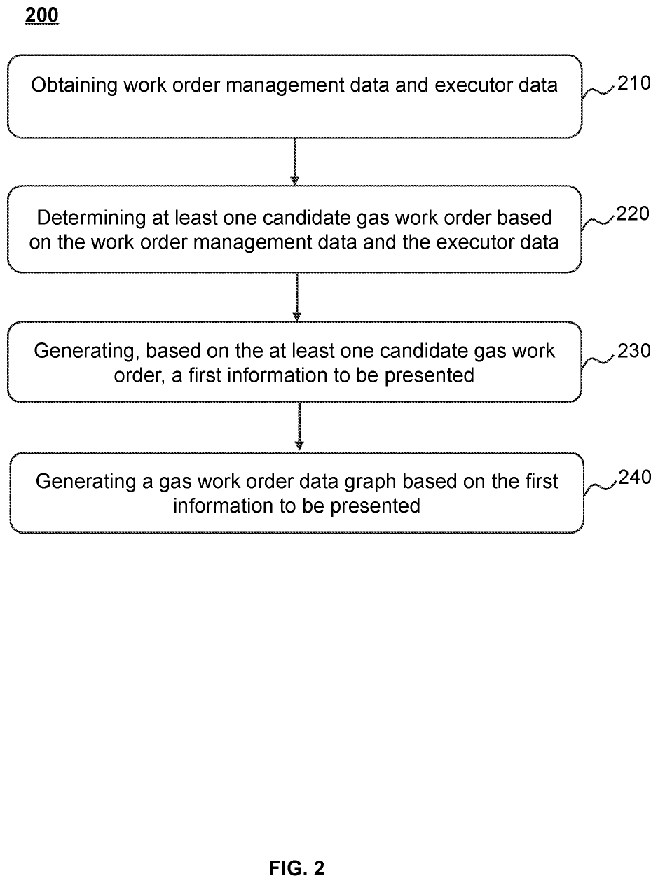

FIG. 2 is a flowchart illustrating an exemplary method for visualizing a work order of a smart gas platform according to some embodiments of the present disclosure. In some embodiments, process 200 may be performed by the smart gas management platform 130 of the Internet of Things system 100 for visualizing a work order of a smart gas platform. As shown in FIG. 2, process 200 includes steps 210-240 described below.

Step 210, obtaining work order management data and executor data.

The work order management data refers to work order operation and maintenance data in a preset time period. The preset time period may be set according to the experience of those skilled in the art. In some embodiments, the work order management data may be equivalent to data to be presented that is retrieved from a work order database. For example, the work order management data may include a number of work orders managed by the smart gas management platform 130 in the preset time period, a number of work orders that require a work order executor to visit the site to execute, etc.

The executor data is data related to an executor of a work order. The executor may include one or more of a gas maintenance person, a gas inspection person, a gas installation person, etc.

In some embodiments, the executor data may include a personnel geographic position and/or a personnel ability level.

The personnel ability level is a grading of a work order executor's ability to handle work orders. For example, the personnel ability level may be classified from level 1 to level 10 (the higher the level is, the higher the ability is) according to the ability of the work order executor.

In some embodiments, the smart gas management platform may obtain the executor data (e.g., a geographic position of an executor) from a terminal configured on the smart gas object platform via the smart gas sensing network platform. In some embodiments, the work order management data may be obtained from the smart gas management platform.

Step 220, determining at least one candidate gas work order based on the work order management data and the executor data.

The candidate gas work order is a gas work order selected for generating information to be presented (e.g., a first information to be presented).

In some embodiments, the smart gas management platform may determine at least one candidate gas work order based on preset work order management data and executor data with a candidate gas work order comparison table.

In some embodiments, the smart gas management platform may determine a matching degree between a work order executor and at least one gas work order based on the work order management data and the executor data, and determine at least one candidate gas work order based on the matching degree.

In some embodiments, the matching degree includes a matching degree between an ability level of a personnel belonging to a user terminal and a type difficulty of a gas work order (personnel ability and work order difficulty). In some embodiments, the matching degree also includes a matching degree between a geographic position of the personnel belonging to the user terminal and a geographic position (distance) of the gas work order. The personnel belonging to the user terminal refers to a work order executor who is currently using the user terminal. In some embodiments, the determining at least one candidate gas work order based on the matching degree includes a relatively precise matching for an individual profile of each work order executor separately. For example, a corresponding candidate gas work order is determined based on the matching degree between each work order executor and the gas work order, and information related to the corresponding candidate gas work order is displayed on the user terminal of each work order executor separately.

In some embodiments, the matching degree may be expressed as a percentage. For example, the matching degree between the personnel belonging to the user terminal and the gas work order may be 90%, 80%, 35%, etc.

In some embodiments, the matching degree may be expressed in terms of a level. For example, a matching degree between 90% and 100% and containing 90% and 100% is a level 1; a matching degree between 80% and 90% and containing 80% is a level 2; and a matching degree between 70% and 80% and containing 70% is a level 3.

In some embodiments, the smart gas management platform may grade the matching degree and use different markings (e.g., different colors, display percentages, one star, two stars, three stars, etc.) for the different grades. In some embodiments, when the matching degree is greater than a threshold, then the executor is capable of executing at least one work order with which it matches, and the smart gas management platform may highlight the work order executor and at least one gas work order with a matching degree greater than the threshold.

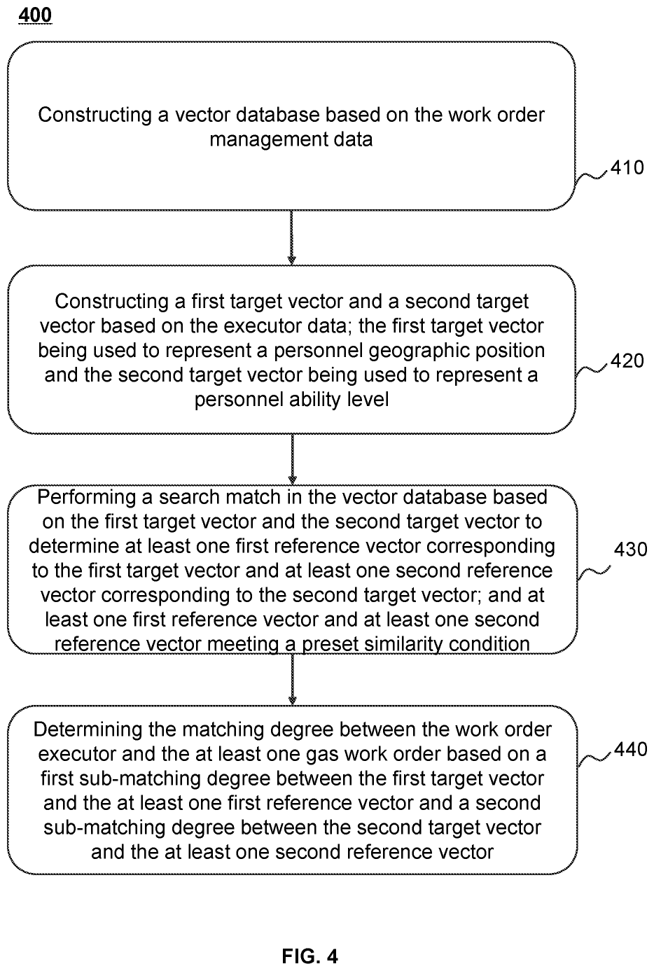

In some embodiments, the smart gas management platform may construct a target vector based on the work order management data and/or based on the executor data, and perform a search and calculation of a reference vector in a vector database based on the target vector to determine the matching degree between the work order executor and at least one gas work order. For more information about this section, please refer to FIG. 4 and its more detailed description.

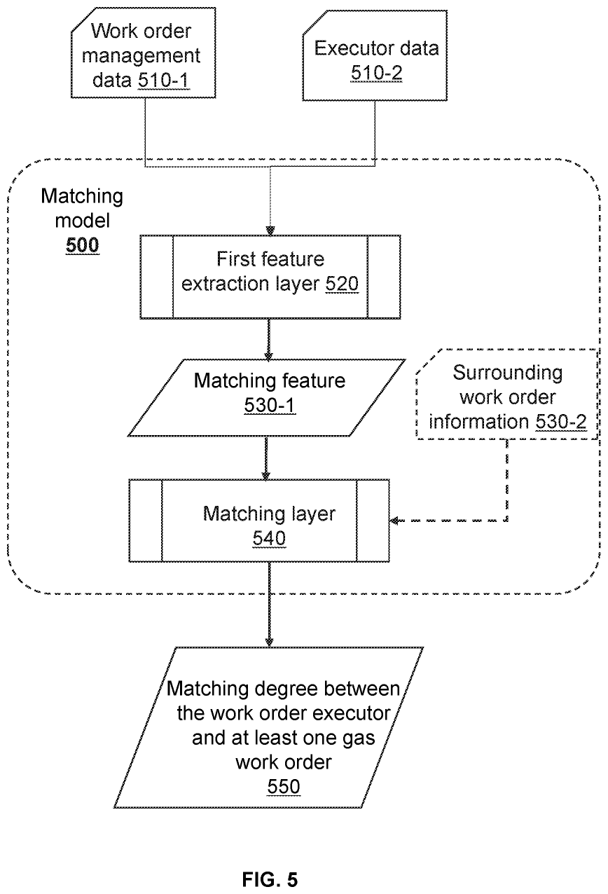

In some embodiments, the smart gas management platform may process the work order management data and the executor data through a matching model to determine the matching degree between the work order executor and the at least one gas work order. For more information about this section, please refer to the more detailed description in FIG. 5 below.

In some embodiments, the smart gas management platform may determine one or more work orders having a matching degree greater than a preset condition with a work order executor as at least one candidate gas work order of the work order executor. The preset condition may be set by those skilled in the art based on experience, e.g., the matching degree is greater than 70%, 80%, etc.

Step 230, generating, based on the at least one candidate gas work order, a first information to be presented.

The first information to be presented is information that requires for visual graphical presentation in at least one candidate gas work order.

In some embodiments, the first information to be presented may include at least one of a type of at least one candidate gas work order, difficulty information of at least one candidate gas work order, geographic position information of at least one candidate gas work order, status information of at least one candidate gas work order, and geographic position information of a work order executor.

In some embodiments, the type of candidate gas work order may include one or more of a repair work order, an installation work order, an inspection work order, a troubleshooting work order, etc.

The difficulty information is information about the difficulty of processing a gas work order. For example, the difficulty information may include a simple repair task, a moderately difficult repair task, a complex repair task, etc.

The geographic position information is information that reflects a geographic position. For example, the geographic position information may include latitude and longitude information.

The status information is information about the processing status of a work order. For example, the status information may include no work order executor receiving an order, a work order executor receiving an order but being not execute it a work order executor taking an order and being executing it but not completing execution, etc.

In some embodiments, the first information to be presented may further include a number of people grabbing orders corresponding to each candidate gas work order in the at least one candidate gas work order.

The number of people grabbing orders is a number of people who select the same candidate gas work order. In some embodiments, the number of people selecting the same candidate gas work order may be one or more.

In some embodiments, the work order executor may select a gas work order from at least one candidate gas work order based on the number of people grabbing orders. For example, if a gas work order has an excessive number of people grabbing orders, another gas work order may be selected.

In some embodiments, in response to the work order executor selecting a gas work order from the at least one candidate gas work order, the number of people grabbing orders of the at least one candidate gas work order is updated.

In some embodiments, the smart gas management platform may retrieve the work order management data and the executor data corresponding to each candidate gas work order in the at least one candidate gas work order to generate the first information to be presented.

Step 240, generating a gas work order data graph based on the first information to be presented. In some embodiments, there may be differences in gas work order data graphs displayed by user terminals for different work order executors (e.g., work order executors with different ability levels).

The gas work order data graph is a graph that may reflect data to be presented by at least one candidate gas work order. In some embodiments, the gas work order data graph may be one or more of a two-dimensional geographic graph, a three-dimensional geographic graph, a gas work order data statistics graph, a gas work order heat graph, etc.

In some embodiments, the gas work order data graph may be a visual chart. The visual chart refers to the presentation of data in the form of a chart. For example, the visual chart may be a bar chart, a line chart, a pie chart, etc.

In some embodiments, the gas work order data graph may classify matching degrees of different candidate gas work orders and mark them with different marker information.

In some embodiments, the smart gas management platform may perform data analysis of the first information to be presented to generate a gas work order data graph.

In some embodiments of the present disclosure, based on the gas work order management data and work order executor data monitored by the object platform, a candidate gas work order is predicted, and then the first information to be presented is obtained to generate a visual data graph of the gas work order to improve the efficiency of gas work order interaction and processing efficiency.

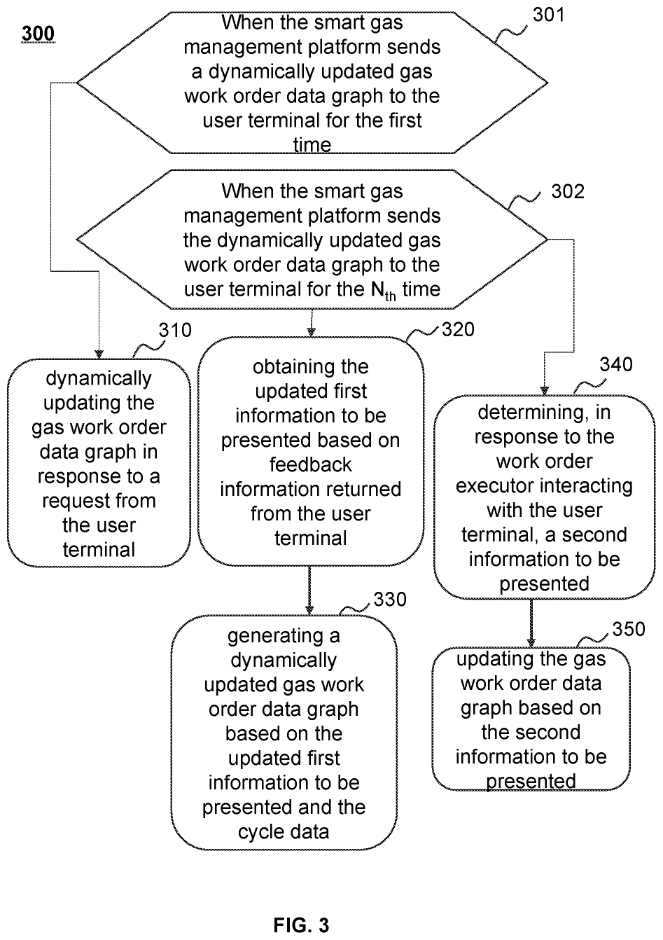

FIG. 3 is a flowchart illustrating an exemplary process for dynamically updating a gas work order data graph according to some embodiments of the present disclosure. In some embodiments, process 300 may be performed by the smart gas management platform of the Internet of Things system 100 for visualizing a work order of a smart gas platform. As shown in FIG. 3, process 300 includes the following steps 310-350.

In some embodiments, the smart gas management platform may send the gas work order data graph to the user terminal and update the gas work order data graph. As shown in condition 301 of FIG. 3, when the smart gas management platform sends a dynamically updated gas work order data graph to the user terminal for the first time, the following step 310 may be used. As shown in condition 302, when the smart gas management platform sends the dynamically updated gas work order data graph to the user terminal for the Nth time, the following steps 320-330 or steps 340-350 may be used, N being a positive integer greater than or equal to 2.

Step 310, dynamically updating the gas work order data graph in response to a request from the user terminal.

The request from the user terminal is a relevant request initiated by a gas user through the user terminal used by the user for obtaining one or more gas work order data graphs. For example, the request may include one or more of a request to view the two-dimensional geographic graph, a request to switch to the three-dimensional geographic graph, a request to switch to the gas work order data statistics graph, a request to switch to the gas work order heat graph, etc.

In some embodiments, the smart gas management platform may dynamically update the gas work order data graph in response to a request from the user terminal. The updating includes a change in the style of the displayed real-time gas work order data graph and a change in the information related to the gas work orders involved in the graph. For example, if the user terminal requests to view a three-dimensional graph, and the smart gas management platform is displaying a two-dimensional geographic graph, the two-dimensional geographic graph may be switched to a three-dimensional graph. As another example, if a user requests special attention to gas work order A, the gas work order A may be highlighted in the gas work order data graph and the user may be alerted using changes in the gas work order A (e.g., changes in time distribution information of the gas work order A, whether the gas work order A is received, etc.).

In some embodiments, the smart gas management platform may update the gas work order data graph in response to obtaining a preset operation. The preset operation is a predefined feasible operation. In some embodiments, the preset operation may include a work order executor selecting a gas work order from at least one candidate gas work order.

For example, when a work order executor selects a gas work order from at least one candidate gas work order and the system confirms that the gas work order is assigned to the work order executor, the gas work order status of the candidate gas work order is converted from no executor taking the order to an executor taking the order but not yet executing it (which is applicable after the executor selects it), then the smart gas management platform updates the work order status of the gas work order in the gas work order data graph.

As another example, when a work order executor selects a gas work order from at least one candidate gas work order, and a number of people grabbing orders of the gas work order increases by 1, the smart gas management platform updates the change in the number of people grabbing orders of the gas work order in the gas work order data graph.

In some embodiments, after the work order executor receives the order, the smart gas management platform may update the gas work order data graph based on cycle data.

The cycle data is data related to update cycles. Work orders with different difficulty have different update cycles (i.e., different cycle data), and the same work order has different update cycles at different time periods. In some examples, since the work order difficulty of work orders that are not received by work order executors affects the cycle data, if the work order status is changed from a not received order status to a received order status after the work order executor receives a difficult work order, which makes the average difficulty of gas work orders decrease, the update cycle of the work order is extended and the update frequency is slow. For more information about the cycle data, please refer to the description in step 330.

In some embodiments, after the work order executor receives the order, the update cycle is adjusted in a timely manner, which can avoid the lag in updating relevant information in the gas work order data graph and better coordinate the execution progress. If a difficult work order is received, shortening the update cycle allows for targeted and timely follow-up of important work order execution progress to meet the work order execution needs.

Step 320, obtaining the updated first information to be presented based on feedback information returned from the user terminal.

The updated first information to be presented is information that is presented via a visual chart after the at least one candidate gas work order is updated. In some embodiments, the updated first information to be presented may include at least one of a updated type of the at least one candidate gas work order, updated difficulty information of the at least one candidate gas work order, updated geographic position information of the at least one candidate gas work order, updated status information of the at least one candidate gas work order, and updated geographic position information of the work order executor.

The feedback information refers to a request related to displaying the gas work order data graph returned by the user terminal. For example, the feedback information may be a cancel of people grabbing orders by an executor, an update of a work order status by a gas executor, a request to expedite the update of the work order data graph by a work order executor, etc.

In some embodiments, the smart gas management platform may, via the smart gas service platform 120, obtain the feedback information returned by the user terminal on the smart gas user platform 110 for processing to obtain the updated first information to be presented.

In some embodiments, the smart gas management platform may send the updated first information to be presented to the user terminal for display.

Step 330, generating a dynamically updated gas work order data graph based on the updated first information to be presented and the cycle data.

In some embodiments, the gas work order data graph may include multiple modules, each of which may be updated individually based on separate update cycles.

The modules may be a collection of data that is part of the gas work order data graph. For example, the modules may include one or more of a collection of data corresponding to a work order, a collection of data corresponding to an executor, etc.

In some embodiments, the modules may be determined based on the first information to be presented. For example, the status information of at least one candidate gas work order is determined to be a module. As another example, the geographic position information of the work order executor is determined as a module.

In some embodiments, the cycle data may reflect an update cycle of at least one module in the gas work order data graph for a certain time period in the future. In some embodiments, when combined together, the update cycles of all modules on the gas work order data graph may constitute the cycle data.

In some embodiments, the smart gas management platform may determine the cycle data based on time data, a type of the at least one candidate gas work order, difficulty information of the at least one candidate gas work order, and status information of the at least one candidate gas work order.

The time data refers to time-related data, such as a time point, a time interval, etc.

In some embodiments, the smart gas management platform may determine the cycle data based on a preset cycle data comparison table, wherein the preset cycle data comparison table records the cycle data corresponding to the time data, the type of the at least one candidate gas work order, the difficulty information of the at least one candidate gas work order, and the status information of the at least one candidate gas work order for each module in the gas work order data graph. For example, the smart gas management platform may query the preset period data comparison table based on the time data (e.g., weekdays or weekends, noon or early morning) to determine the cycle data, e.g., a cycle corresponding to weekdays is shorter and more frequently updated than weekends, and a cycle corresponding to noon is shorter and more frequently updated than early morning.

In some embodiments, work orders with higher importance and/or difficulty are updated more frequently (i.e., with a shorter update cycle) to facilitate timely understanding of the execution of the latest important/big difficulty work orders, and may be updated in time to generate and present gas problem help information when there is an abnormality in the execution. For more information about the gas problem help information, please refer to the description of steps 340-350.

In some embodiments of the present disclosure, as the updating of the gas work order data graph requires a large amount of data calculation by the smart gas management platform, it consumes more resources of the smart gas management platform. By dynamically adjusting the cycle data, when low activity is expected (e.g., late at night), the update cycle may be appropriately extended to reduce data operation costs and avoid unnecessary waste; when it is a work order with high importance and/or difficulty, the update cycle may be appropriately shortened to understand the execution of the latest important/big difficulty work orders in a timely manner to improve operation efficiency.

In some embodiments, the smart gas management platform may dynamically update the first information to be presented based on the cycle data, and then generate a dynamically updated gas work order data graph based on the dynamically updated first information to be presented.

In some embodiments, the gas work order data graph may be a dynamically updated gas work order data graph of one or more modules. For example, the smart gas management platform may dynamically update only the type of at least one candidate gas work order in the first information to be presented based on the cycle data, and then generate a dynamically updated gas work order data graph based on the type of the at least one candidate gas work order after the dynamic update. As another example, the gas management platform may dynamically update all of the first information to be presented based on the cycle data, and then generate a dynamically updated gas work order data graph based on all of the dynamically updated first information to be presented.

Step 340, determining, in response to the work order executor interacting with the user terminal, a second information to be presented.

The interaction refers to an interaction between an actuator and the user terminal. For example, the interaction may include a user clicking on a work order icon on the terminal and an additional small display box in the gas work order data graph on the screen showing specific help information for that work order.

In some embodiments, the interaction may include an active interaction and a passive interaction.

The active interaction refers to the user actively inputting information to interact with the user terminal.

The passive interaction refers to the user terminal actively updating the to be presented information on the gas work order data graph when an unexpected event occurs or an individual user preset condition is met, and notifying the user to interact based on that to be presented information. For example, the passive interaction may include user A presetting the smart gas user platform 110 to notify when a certain work order is displayed. When such a work order is displayed on the smart gas user platform 110, then the smart gas user platform 110 sends a separate notification to inform user A, and then user A performs the passive interaction based on the notification.

In some embodiments, the active interaction may include one or more of touch screen click interaction, input data interaction, and input voice interaction. The passive interaction may include a burst gas event interaction and/or a triggered user preset condition interaction.

The burst gas event interaction is an emergency task for a burst gas event that is actively updated on the gas work order data graph and the user interacts based on the emergency task. For example, the user terminal's gas work order data graph is actively updated with an emergency task for a sudden gas event and a notification is sent to the user terminal, and the user interacts on the user interaction interface based on the emergency task and selects to receive the order.

The second information to be presented is information to be presented that is determined based on an interaction that occurs between an executor and the user terminal. The information to be presented is information in at least one candidate gas work order requires a visual graphical presentation determined by an interaction.

In some embodiments, the second information to be presented may include at least work order time distribution information.

The work order time distribution information may reflect an estimated probability that a gas work order is completed at different estimated completion times. For example, the work order time distribution information may reflect the estimated probability that the time of completing the gas work order from a current moment to the completion of the gas work order is 30 min-40 min as 20%, the estimated probability that the time of completing the gas work order from a current moment to the completion of the gas work order is 40 min-50 min as 60%, the estimated probability that the time of completing the gas work order from a current moment to the completion of the gas work order is 50 min-60 min as 10%, the estimated probability that the time of completing the gas work order from a current moment to the completion of the gas work order is 60 min-70 min as 5%, and the estimated probability that the time of completing the gas work order from a current moment to the completion of the gas work order is 70 min-80 min as 5%.

In some embodiments, the second information to be presented may further include gas problem help information from an executor who has executed a gas work order.

The gas problem help information is help information about a gas work order sent by an executor. For example, the gas problem help information may include a gas work order lacking repair materials, a gas work order requiring additional manpower, etc.

Each gas problem help information has a gas problem help information display scope to which it belongs.

In some embodiments, the gas problem help information display scope relates to the difficulty information of the gas work order, the geographic position information of the gas work order, the geographic position information of the work order executor, and the ability level of the personnel.

The gas problem help information display scope may include displaying the gas problem help information at the user terminal of the work order executor in a certain geographic region (e.g., within a range of 3 km), and may also include displaying the gas problem help information at the user terminal of the work order executor within a specific ability level (e.g., ability level 2 and above).

The method for determining the gas problem help information display scope may include determining a display scope of the gas problem help information based on constructing a vector database or a clustering binning bucket.

In some embodiments, distance data is determined based on the geographic position information of the gas work order and the geographic position information of the work order executor, a target vector is established based on the distance data and the difficulty information of the gas work order, a matching is performed in the known vector database, and an associated vector whose vector distance is less than a preset threshold and an executor corresponding to the associated vector (the distance and level of this executor meeting the requirements of the work order that sends help information) are determined by a vector distance calculation and a comparison judgment, then the help information is displayed to these executors. For more information about the constructing the vector database, please refer to FIG. 4 and its more detailed description.

The types of help information include at least a material help, a help for additional manpower, a help for additional higher level personnel, etc. In some embodiments, the help information that does not involve additional manpower does not need to consider matching between the difficulty of the gas work order and the ability of the work order execution personnel, and needs to give priority to the appropriate distance, such as material help only needs to be the appropriate distance, etc.

In some embodiments of the present disclosure, the efficiency of gas problem resolution can be improved by only displaying the gas problem help information to other executors within a certain range of this work order and not displaying the gas problem help information that are far away to other executors.

In some embodiments, in response to the work order executor interacting with the user terminal, the smart gas management platform may determine and display the second information to be presented.

Step 350, updating the gas work order data graph based on the second information to be presented.

In some embodiments, the smart gas management platform may update the gas work order data graph based on the second information to be presented, and send the dynamically updated gas work order data graph to at least one user terminal.

In some embodiments, based on monitored data and predicted data by the platform (e.g., gas work order time distribution), and feedback data from the user terminal, the visual data graph of gas work orders is dynamically updated to avoid lagging gas work order updates; and the gas work order interaction efficiency and processing efficiency are improved based on the dynamically updated data graph.

It should be noted that the above description of process 300 is intended to be exemplary and illustrative only, and does not limit the scope of application of the present disclosure. Various amendments and changes can be made to process 300 for those skilled in the art under the guidance of the present disclosure. However, these amendments and changes remain within the scope of the present disclosure.

FIG. 4 is a flowchart illustrating an exemplary process for determining a matching degree between a work order executor and at least one gas work order according to some embodiments of the present disclosure.

Step 410, constructing a vector database based on the work order management data.

The work order management data may include historically stored and real-time updated work order management data. The vector database is a database for storing, indexing, and querying vectors, for example, the Milvus vector database.

In some embodiments, vectors in the vector database may include at least two types of feature vectors corresponding to the work order management data, one type of feature vector is used for representing the geographic position of the work order and the other type of feature vector is used for representing the difficulty level of the work order.

In some embodiments, a feature vector in the vector database may be determined based on the work order management data. For example, the user may upload the work order management data to a server, which parses original data to obtain parsed data (e.g., work order data being parsed as work order geographic position, work order difficulty level, etc.), feature vectors of each parsed data are obtained by a model inference (e.g., CNN, ResNet), and finally the feature vectors are imported into the vector database to complete the construction of the vector database.

In some embodiments, the vector database also stores work order information corresponding to each feature vector, for example, each feature vector has its corresponding work order to be executed, and each feature vector is generated based on the corresponding information of its corresponding work order to be executed.

Step 420, constructing a first target vector and a second target vector based on the executor data; the first target vector being used to represent a personnel geographic position and the second target vector being used to represent a personnel ability level.

In some embodiments, the smart gas management platform may separately construct a first target vector and a second target vector based on a personnel geographic position and a personnel ability level in the executor data. For example, there are a first target vector a and a second target vector b, a representing a current geographic position of a work order executor and b representing an ability level of the work order executor.

Step 430, performing a search match in the vector database based on the first target vector and the second target vector to determine at least one first reference vector corresponding to the first target vector and at least one second reference vector corresponding to the second target vector; wherein the at least one first reference vector and the at least one second reference vector meet a preset similarity condition.

The first reference vector and the second reference vector are two types of feature vectors in the vector database that meet the preset similarity condition compared to the first target vector and the second target vector. The first reference vector is used to represent a work order geographic position; and the second reference vector is used to represent a work order difficulty level.

The second reference vector and the second target vector may be represented in the same manner, i.e., the manner of representing the work order difficulty level and the manner of representing the ability level of the executor may be the same, e.g., both may be represented as levels 1-10 (the higher the level is, the greater the difficulty, and the higher the ability is).

The preset similarity condition may be set by those skilled in the art based on experience. The preset similarity condition may include a first condition for determining the first reference vector, and a second condition for determining the second reference vector. The first condition may be that a vector distance between the first target vector and the at least one first reference vector is less than a first distance threshold, i.e., a spatial distance between the executor corresponding to the first target vector and the work order to be executed corresponding to the first reference vector needs to be less than a spatial distance threshold. The second condition may be that a vector distance between the second target vector and the at least one second reference vector is less than a second distance threshold, i.e., a level difference between the ability level of the executor of the work order corresponding to the second target vector and the difficulty level of the work order to be executed corresponding to the second reference vector is less than a level difference threshold. The first distance threshold is positively correlated with the spatial distance threshold and the second distance threshold is positively correlated with the level difference threshold. The first distance threshold and the second distance threshold may be set and adjusted according to an actual required distance threshold and a level difference threshold. By way of example only, a level difference value may be a difference between the ability level of the executor and the difficulty level of the work order to be executed, and the level difference threshold may be preset to be greater than or equal to 0 and less than or equal to 2.

In some embodiments, the smart gas management platform may perform a search match in the vector database based on the first target vector and the second target vector to search for two types of feature vectors that meet the preset similarity condition as the first reference vector and the second reference vector.

In some embodiments, the smart gas management platform may determine at least one gas work order based on the first reference vector and the second reference vector, for example, the smart gas management platform may separately determine the same work order to be executed in the work order to be executed corresponding to the first reference vector and the second reference vector as at least one gas work order.

Step 440, determining the matching degree between the work order executor and the at least one gas work order based on a first sub-matching degree between the first target vector and the at least one first reference vector and a second sub-matching degree between the second target vector and the at least one second reference vector.

The first sub-matching degree is a matching degree between the first target vector and the first reference vector. The first sub-matching degree may be determined based on a vector distance between the first target vector and the first reference vector, e.g., the smaller the vector distance is, the greater the first sub-matching degree is. In some embodiments, a correspondence table between the vector distance and the first sub-matching degree may be preset based on historical experience, and the first sub-matching degree between the first target vector and the first reference vector may be determined based on a calculated vector distance look-up table between the first target vector and the first reference vector.

The second sub-matching degree is a matching degree between the second target vector and the second reference vector. The second sub-matching degree may be determined based on a vector distance between the second target vector and the second reference vector, e.g., the smaller the vector distance is, the greater the second sub-matching degree is. In some embodiments, the second sub-matching degree between the second target vector and the second reference vector may likewise be determined based on the vector distance look-up table, more contents refer to related descriptions of the first sub-matching degree.

In some embodiments, the smart gas management platform may determine the first sub-matching degree and the second sub-matching degree corresponding to each gas work order, respectively, based on the foregoing approaches.

In some embodiments, the smart gas management platform may determine a matching degree between the work order executor and the gas work order based on the first sub-matching degree and the second sub-matching degree between the work order executor and the gas work order in various ways. For example, the smart gas management platform may use an average value of the first sub-matching degree and the second sub-matching degree corresponding to the gas work order as the matching degree between the work order executor and the gas work order. For another example, the smart gas management platform may determine the matching degree between the work order executor and the gas work order based on a weighted sum of the first sub-matching degree and the second sub-matching degree corresponding to the gas work order. The weight values corresponding to the first sub-matching degree and the second sub-matching degree may be preset, e.g., for a gas work order that requires a quick arrival of personnel, the weight value of the first sub-matching degree may be greater than the weight value of the second sub-matching degree when calculating the matching degree.

In some embodiments, the smart gas management platform may adjust the matching degree based on actual needs. The adjustment of the matching degree includes a manual adjustment and an automatic rule-based adjustment. In some embodiments, if the personnel has a high ability level (e.g., work order execution expert), its corresponding spatial distance threshold may be adjusted to be high, i.e., the first distance threshold used for determining the first target vector may be increased so that the range of work orders that can be executed is larger, avoiding the problem that work orders of high difficulty levels cannot be matched to processors in a timely manner, and the work order disposal benefit of work orders of high difficulty levels is also generally greater than its transportation cost and time cost incurred.

In some embodiments of the present disclosure, by combining the matching degree between the work order executor and the gas work order, the gas work order assignment can be made more scientific and reasonable, so that the work order executor can be matched to the appropriate gas work order, which in turn can improve the work order execution efficiency and optimize the work order execution results.

FIG. 5 is a flowchart illustrating another exemplary process for determining the matching degree between a work order executor and at least one gas work order according to some embodiments of the present disclosure.

In some embodiments, the smart gas management platform may process the work order management data and the executor data via a matching model to determine a matching level between the work order executor and the at least one gas work order. In some embodiments, the matching model may be a machine learning model. For example, a neural network model (NN), a deep neural network model (DNN), or any combination thereof.

As shown in FIG. 5, the matching model 500 may include a first feature extraction layer 520 and a matching layer 540 that are connected in sequence.

In some embodiments, the first feature extraction layer 520 may determine a matching feature 530-1 based on work order management data 510-1 and executor data 510-2.

The matching feature refers to a vector consisting of difficulty information of at least one gas work order, geographic position information of at least one gas work order, repair time of at least one gas work order, geographic position information of a work order executor, and a personnel ability level. For example, the matching feature may be a vector p(x, y, m, n, z), where x represents the difficulty information of at least one gas work order, y represents the geographic position information of at least one gas work order, m represents the repair time of at least one gas work order, n represents the geographic position information of the work order executor, and z represents the personnel ability level.

The repair time is the time when the work order starts to be executed after a gas work order is received.

For more information about the definition of the personnel ability level, work order management data, and executor data, please refer to FIG. 2 and their related descriptions.

In some embodiments, an input of the first feature extraction layer 520 may include the work order management data 510-1 and the executor data 510-2, and an output of the first feature extraction layer 520 may include the matching feature 530-1.

In some embodiments, the matching layer 540 may determine a matching degree 550 between a work order executor and at least one gas work order based on the matching feature 530-1.

In some embodiments, an input of the matching layer 540 may include the matching feature 530-1 and an output of the matching layer 540 may include the matching degree 550 between the work order executor and at least one gas work order. For more information about the definition of the matching degree, please refer to the corresponding description in FIG. 2.

In some embodiments, an input of the matching layer 540 may also include surrounding work order information 530-2. The surrounding work order information is work order information that relates to the circumstances surrounding a matching work order. The matching work order includes a work order that the work order executor is currently executing, and also includes a work order that the work order executor has received but is not yet executing. The surrounding work order information may include a number of work orders that is not be received around a matching work order that match the work order executor.

In some embodiments, when there are a high number of associated matching work orders around a gas work order, the gas work order is assigned by increasing the matching degree between that gas work order and the executor. The associated matching work orders are work orders being not received that match the executor of the gas work order, or work orders that have a high probability of occurring in the future (e.g., a high probability of a gas failure occurring in the future, and thus a high probability of a corresponding repair work order being generated).

By combining the surrounding work order situation, the work order executors can be quickly dispatched to handle the associated matching work orders that exist around the matching work order to improve the repair efficiency.

In some embodiments, the matching model 500 may be obtained by jointly training by the first feature extraction layer 520 and the matching layer 540 based on multiple training samples with labels.

In some embodiments, the training samples may include a work order management data sample and an executor data sample. The labels may be known matching degrees of historical work order executors to at least one gas work order. In some embodiments, the labels may be obtained from historical data stored on the smart gas data center or obtained by manual annotation.

In some embodiments, the training samples may also include historical surrounding work order information.

In some embodiments, the multiple training samples with labels may be input into an initial first feature extraction layer, and then matching features output from the initial first feature extraction layer are input into an initial matching layer, and a loss function is constructed from the labels and the output results of the initial matching layer, and parameters of the initial first feature extraction layer and the initial matching layer are iteratively updated by gradient descent or other methods based on the loss function. The trained matching model is obtained. The model training is completed when a preset condition is met, and the trained matching model is obtained. The preset condition may be the convergence of the loss function, the number of iterations reaching a threshold, etc.

In some embodiments of the present disclosure, the matching model enables fast and accurate prediction of a matching degree between a work order executor and at least one gas work order based on the work order management data and the executor data. In addition, analysis is performed in conjunction with surrounding work order information to further improve the accuracy and matching efficiency of predicting the matching degree between the work order executor and the at least one gas work order.

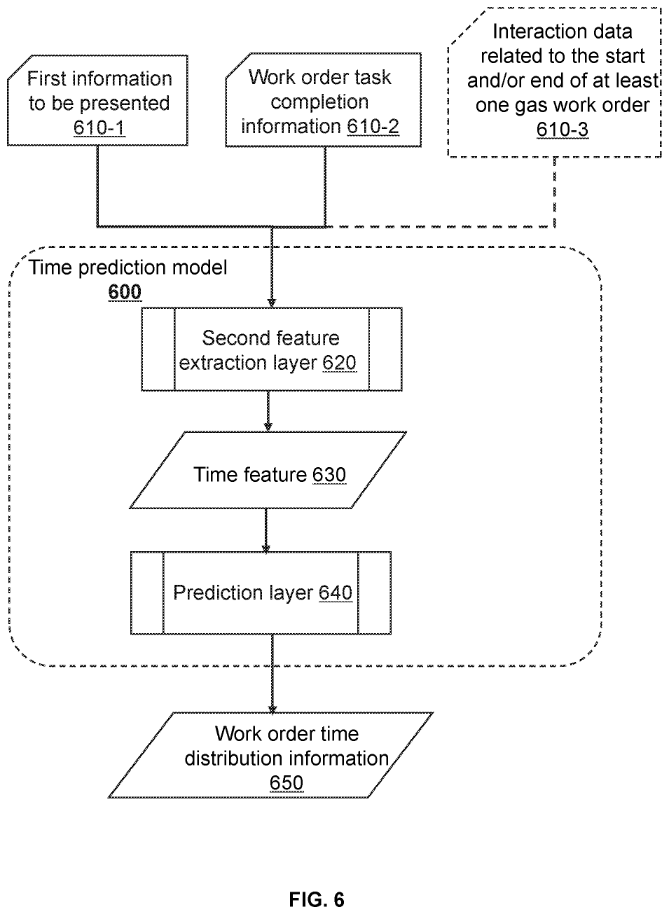

FIG. 6 is a flowchart illustrating an exemplary process for determining work order time distribution information according to some embodiments of the present disclosure.

In some embodiments, the smart gas management platform may process the first information to be presented and work order task completion information through a time prediction model to determine work order time distribution information. In some embodiments, the time prediction model may be a machine learning model, e.g., a neural network model, etc.

As shown in FIG. 6, the time prediction model 600 may include a second feature extraction layer 620 and a prediction layer 640 that are connected in sequence.

In some embodiments, the second feature extraction layer 620 may determine a time feature 630 based on the first information to be presented 610-1 and the work order task completion information 610-2.

The time feature refers to a vector consisting of difficulty information of a gas work order task and repair time, personnel ability level, and gas work order task completion information.

The gas work order task completion information is completion degree information of gas work order task. For example, the gas work order task completion information refers to ⅓ of a total amount of gas work orders that have been completed.

For more information about the definitions of the first information to be presented, the difficulty information, please refer to FIG. 2 and their related descriptions above.

For more information about the definitions of the repair time and ability level, please refer to FIG. 5 and their related descriptions above.

In some embodiments, an input of the second feature extraction layer 620 may include the first information to be presented 610-1 and the work order task completion information 610-2, and an output of the second feature extraction layer 620 may include the time feature 630.

In some embodiments, the input of the second feature extraction layer 620 may also include interaction data 610-3 related to the start and/or end of the at least one gas work order.

In some embodiments, the interaction data related to the start and/or end of the at least one gas work order may include the work order executor initiating a request for a work order extension or secondary execution (i.e., re-execution). The work order extension is an extension of the scheduled completion time of the work order. The secondary execution is that the work order is executed again by the current executor or another executor when the execution of the work order fails. In some embodiments, the second data to be presented is updated based on the interaction data related to the start and/or end of the at least one gas work order and the updated second data to be presented is displayed on the gas work order data graph.

In some embodiments of the present disclosure, by inputting the interaction data related to the start and/or end of the at least one gas work order, it helps the time prediction model to output reasonable, accurate, and more realistic the work order time distribution information.

In some embodiments, the prediction layer 640 may determine work order time distribution information 650 based on the time feature 630. In some embodiments, the prediction layer 640 may be a DNN model.

In some embodiments, an input of the prediction layer 640 may include the time feature 630 and an output of the prediction layer 640 may include the work order time distribution information 650.

For more information about the definition of the work order time distribution information, please refer to FIG. 3 and the related description above. In some embodiments, the work order time distribution information may be represented as a bar chart, a pie chart, etc.

In some embodiments of the present disclosure, the prediction results of the time prediction model can assist work order executors in making more scientific work time arrangements and reasonable decisions in the process of executing work orders. For example, the work order executor can check the predicted time of the executed work order to judge whether there is a possibility of overtime; or check the end time of other work orders nearby to invite help or send help information, etc.

In some embodiments, the time prediction model 600 may be obtained by jointly training the second feature extraction layer 620 and the prediction layer 640 based on multiple training samples with labels.

In some embodiments, the training samples may include historical first information to be presented and historical work order task completion information. The labels may be known historical work order time distribution information. In some embodiments, the labels may be obtained from historical data stored on the smart gas data center or obtained by manual annotation.

In some embodiments, the training samples may further include historical interaction data related to the start and/or end of at least one gas work order.

In some embodiments of the present disclosure, by considering the interaction data related to the start and/or end of the at least one gas work order, the impact on the work order time distribution information by the current executor or other executors executing the work order again is avoided when the work order executor actively requests the work order extension or the current work order execution fails, and the reasonableness and accuracy of output of the time prediction model is ensured so that the output results are more in line with the actual situation.

In some embodiments, the multiple training samples with labels may be input into an initial second feature extraction layer, and then time features output from the initial second feature extraction layer are input into the initial prediction layer to obtain a trained time prediction model. For more information about the specific training process of the time prediction model, please refer to FIG. 5 and its related description above.

In some embodiments of the present disclosure, the time prediction model predicts the time distribution information of work orders, thereby obtaining the predicted completion time for executing the work orders and judging whether there is a possibility of overrunning the time used for completing the work orders, which helps to manage the large amount of work order data in a more efficient manner.

The basic concepts have been described above, apparently, in detail, as will be described above, and does not constitute limitations of the disclosure. Although there is no clear explanation here, those skilled in the art may make various modifications, improvements, and modifications of present disclosure. This type of modification, improvement, and corrections are recommended in present disclosure, so the modification, improvement, and the amendment remain in the spirit and scope of the exemplary embodiment of the present disclosure.

At the same time, present disclosure uses specific words to describe the embodiments of the present disclosure. As “one embodiment”, “an embodiment”, and/or “some embodiments” means a certain feature, structure, or characteristic of at least one embodiment of the present disclosure. Therefore, it is emphasized and should be appreciated that two or more references to “an embodiment” or “one embodiment” or “an alternative embodiment” in various parts of present disclosure are not necessarily all referring to the same embodiment. Further, certain features, structures, or features of one or more embodiments of the present disclosure may be combined.

Moreover, unless the claims are clearly stated, the sequence of the present disclosure, the use of the digital letters, or the use of other names is not configured to define the order of the present disclosure processes and methods. Although some examples of the disclosure currently considered useful in the present disclosure are discussed in the above disclosure, it should be understood that the details will only be described, and the appended claims are not limited to the disclosure embodiments. The requirements are designed to cover all modifications and equivalents combined with the substance and range of the present disclosure. For example, although the implementation of various components described above may be embodied in a hardware device, it may also be implemented as a software only scheme, e.g., an installation on an existing server or mobile device.

Similarly, it should be noted that in order to simplify the expression disclosed in the present disclosure and help the understanding of one or more embodiments, in the previous description of the embodiments of the present disclosure, a variety of features are sometimes combined into one embodiment, drawings or description thereof. However, this disclosure method does not mean that the characteristics required by the object of the present disclosure are more than the characteristics mentioned in the claims. Rather, claimed subject matter may lie in less than all features of a single foregoing disclosed embodiment.

In some embodiments, numbers expressing quantities of ingredients, properties, and so forth, configured to describe and claim certain embodiments of the application are to be understood as being modified in some instances by the term “about,” “approximate,” or “substantially”. Unless otherwise stated, “approximately”, “approximately” or “substantially” indicates that the number is allowed to vary by ±20%. Accordingly, in some embodiments, the numerical parameters used in the specification and claims are approximate values, and the approximate values may be changed according to characteristics required by individual embodiments. In some embodiments, the numerical parameters should be construed in light of the number of reported significant digits and by applying ordinary rounding techniques. Although the numerical domains and parameters used in the present disclosure are configured to confirm its range breadth, in the specific embodiment, the settings of such values are as accurately as possible within the feasible range.

For each patent, patent application, patent application publication and other materials referenced by the present disclosure, such as articles, books, instructions, publications, documentation, etc., hereby incorporated herein by reference. Except for the application history documents that are inconsistent with or conflict with the contents of the present disclosure, and the documents that limit the widest range of claims in the present disclosure (currently or later attached to the present disclosure). It should be noted that if a description, definition, and/or terms in the subsequent material of the present disclosure are inconsistent or conflicted with the content described in the present disclosure, the use of description, definition, and/or terms in this manual shall prevail.

Finally, it should be understood that the embodiments described herein are only configured to illustrate the principles of the embodiments of the present disclosure. Other deformations may also belong to the scope of the present disclosure. Thus, as an example, not limited, the alternative configuration of the present disclosure embodiment may be consistent with the teachings of the present disclosure. Accordingly, the embodiments of the present disclosure are not limited to the embodiments of the present disclosure clearly described and described.

What is claimed is:

1. A method for visualizing a work order of a smart gas platform, wherein the method is executed by a smart gas management platform of an Internet of Things system for visualizing a work order of a smart gas platform, the method comprises:
obtaining work order management data and executor data;
determining at least one candidate gas work order based on the work order management data and the executor data;
generating, based on the at least one candidate gas work order, a first information to be presented; wherein the first information to be presented includes at least one of a type of the at least one candidate gas work order, difficulty information of the at least one candidate gas work order, geographic position information of the at least one candidate gas work order, status information of the at least one candidate gas work order, and geographic position information of a work order executor; and
generating a gas work order data graph based on the first information to be presented, the gas work order data graph being a visual chart.

2. The method of claim 1, wherein the Internet of Things system for visualizing a work order of a smart gas platform further includes a smart gas user platform, a smart gas service platform, a smart gas sensing network platform and a smart gas object platform;
the smart gas user platform is configured to send feedback information and a gas operation management information inquiry instruction of a gas user to the smart gas service platform; and receive gas work order visualization information uploaded by the smart gas service platform;
the smart gas service platform is configured to receive the gas operation management information query instruction from the smart gas user platform, upload operation management information to the smart gas user platform; send the gas operation management information query instruction to the smart gas management platform, receive the operation management information uploaded by the smart gas management platform;
the smart gas management platform is configured to receive the gas operation management information query instruction from the smart gas service platform, upload the gas operation management information to the smart gas service platform; send an instruction to obtain gas device related data to the smart gas sensing network platform, receive gas device related data uploaded by the smart gas sensing network platform;
the smart gas sensing network platform is configured to receive the instruction to obtain gas device related data from the smart gas management platform, upload the gas device related data to the smart gas management platform; receive the gas device related data uploaded by the smart gas object platform, send the instruction to obtain gas device related data to the smart gas object platform; and
the smart gas object platform is configured to receive the instruction to obtain gas device related data sent by the smart gas sensing network platform, and upload the gas device related data to the smart gas sensing network platform.

3. The method of claim 1, wherein the determining at least one candidate gas work order based on the work order management data and the executor data includes:
determining, based on the work order management data and the executor data, a matching degree between the work order executor and at least one gas work order; and
determining, based on the matching degree, the at least one candidate gas work order.

4. The method of claim 3, wherein the determining, based on the work order management data and the executor data, a matching degree between the work order executor and at least one gas work order includes:
constructing a vector database based on the work order management data;
constructing a first target vector and a second target vector based on the executor data; the first target vector being used to represent a personnel geographic position and the second target vector being used to represent a personnel ability level;
performing a search match in the vector database based on the first target vector and the second target vector to determine at least one first reference vector corresponding to the first target vector and at least one second reference vector corresponding to the second target vector; wherein the at least one first reference vector and the at least one second reference vector meet a preset similarity condition; and
determining the matching degree between the work order executor and the at least one gas work order based on a first sub-matching degree between the first target vector and the at least one first reference vector, and a second sub-matching degree between the second target vector and the at least one second reference vector.

5. The method of claim 3, wherein the determining, based on the work order management data and the executor data, a matching degree between the work order executor and at least one gas work order includes:
determining the matching degree between the work order executor and the at least one gas work order by processing the work order management data and the executor data through a matching model, the matching model being a machine learning model.

6. The method of claim 5, wherein the matching model includes a first feature extraction layer and a matching layer, the first feature extraction layer being used to determine a matching feature by processing the work order management data and the executor data; and the matching layer being used to determine the matching degree between the work order executor and the at least one gas work order by processing the matching feature.

7. The method of claim 1, wherein the method further includes:
updating the gas work order data graph in response to obtaining a preset operation; the preset operation including selecting a gas work order by the work order executor from the at least one candidate gas work order.

8. The method of claim 1, wherein the first information to be presented further includes a number of people grabbing orders corresponding to each candidate gas work order in the at least one candidate gas work order.

9. The method of claim 1, wherein the method further includes:
determining, in response to the work order executor interacting with a user terminal, a second information to be presented; the interaction including an active interaction and a passive interaction, the second information to be presented including at least work order time distribution information; and
updating the gas work order data graph based on the second information to be presented.

10. The method of claim 9, wherein the work order time distribution information is determined by a process including:
determining the work order time distribution information by processing the first information to be presented and work order task completion information through a time prediction model, the time prediction model being a machine learning model.

11. The method of claim 10, wherein an input of the time prediction model further includes: interaction data related to the start or end of at least one gas work order;
the determining the work order time distribution information by processing the first information to be presented and work order task completion information through a time prediction model includes:
determining the work order time distribution information by processing the first information to be presented, the work order task completion information and the interaction data related to the start or end of at least one gas work order through the time prediction model.

12. The method of claim 9, wherein the active interaction includes one or more of touch screen click interaction, input data interaction, and input voice interaction, and the passive interaction includes a burst gas event interaction or a trigged user preset condition interaction.

13. An Internet of Things system for visualizing a work order of a smart gas platform, wherein the smart gas management platform of the Internet of Things system for visualizing a work order of a smart gas platform is configured to:
obtain work order management data and executor data;
determine at least one candidate gas work order based on the work order management data and the executor data;
generate, based on the at least one candidate gas work order, a first information to be presented; wherein the first information to be presented includes at least one of a type of the at least one candidate gas work order, difficulty information of the at least one candidate gas work order, geographic position information of the at least one candidate gas work order, status information of the at least one candidate gas work order, and geographic position information of a work order executor; and
generate a gas work order data graph based on the first information to be presented, the gas work order data graph being a visual chart.

14. The Internet of Things system of claim 13, wherein the Internet of Things system for visualizing a work order of a smart gas platform further includes a smart gas user platform, a smart gas service platform, a smart gas sensing network platform and a smart gas object platform;
the smart gas user platform is configured to send feedback information and a gas operation management information inquiry instruction of a gas user to the smart gas service platform; and receive gas work order visualization information uploaded by the smart gas service platform;
the smart gas service platform is configured to receive the gas operation management information query instruction from the smart gas user platform, upload operation management information to the smart gas user platform; send the gas operation management information query instruction to the smart gas management platform, receive the operation management information uploaded by the smart gas management platform;
the smart gas management platform is configured to receive the gas operation management information query instruction from the smart gas service platform, upload the gas operation management information to the smart gas service platform; send an instruction to obtain gas device related data to the smart gas sensing network platform, receive gas device related data uploaded by the smart gas sensing network platform;
the smart gas sensing network platform is configured to receive the instruction to obtain gas device related data from the smart gas management platform, upload the gas device related data to the smart gas management platform; receive the gas device related data uploaded by the smart gas object platform, send the instruction to obtain gas device related data to the smart gas object platform; and
the smart gas object platform is configured to receive the instruction to obtain gas device related data sent by the smart gas sensing network platform, and upload the gas device related data to the smart gas sensing network platform.

15. The Internet of Things system of claim 13, wherein the smart gas management platform is further configured to:
determine, based on the work order management data and the executor data, a matching degree between the work order executor and at least one gas work order; and
determine, based on the matching degree, the at least one candidate gas work order.

16. The Internet of Things system of claim 13, wherein the smart gas management platform is further configured to:
update the gas work order data graph in response to obtaining a preset operation; the preset operation including selecting a gas work order by the work order executor from the at least one candidate gas work order.

17. The Internet of things system of claim 13, wherein the first information to be presented further includes a number of people grabbing orders corresponding to each candidate gas work order in the at least one candidate gas work order.

18. The Internet of Things system of claim 13, wherein the smart gas management platform is further configured to:
determine, in response to the work order executor interacting with a user terminal, a second information to be presented; the interaction including an active interaction and a passive interaction, the second information to be presented including at least work order time distribution information; and
update the gas work order data graph based on the second information to be presented.

19. The Internet of Things system of claim 13, wherein the active interaction includes one or more of touch screen click interaction, input data interaction, and input voice interaction, and the passive interaction includes a burst gas event interaction or a trigged user preset condition interaction.

20. A non-transitory computer-readable storage medium, comprising a set of instructions, wherein when executed by a processor, the method for visualizing a work order of a smart gas platform of claim 1 is implemented.
